(19) United States
(12) Patent Application Publication
(10) Pub. No.: US 2008/0203721 A1
(43) Pub. Date: Aug. 28, 2008

(54) INFORMATION CARRYING DEVICE

(75) Inventors: Klas Hakan Petersson, Lund (SE); Johan Martin Nyman, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/743,228

(22) Filed: May 2, 2007

Related U.S. Application Data
(60) Provisional application No. 60/891,964, filed on Feb. 28, 2007.

(51) Int. Cl. B42D 15/00

(52) U.S. Cl. 283/99; 72/338

(57) ABSTRACT

The invention relates to an information carrying device for an electronic portable device, comprising at least one compartment, which is accessible through an opening of the terminal, and a label, which is accessible through the terminal opening and movably connected to the terminal for movement between a storing position and a reading position and arranged externally of the compartment; a method for manufacturing the information carrying device in one operation, and an electronic portable device comprising the information carrying device

### CROSS-REFERENCE TO RELATED APPLICATION

This application claims the benefit of U.S. Provisional Patent Application Ser. No. 60/891,964, filed Feb. 28, 2007, which is incorporated herein by reference in its entirety.

### TECHNICAL FIELD OF THE INVENTION

The present invention relates to an electronic portable terminal, comprising at least one information carrying device, e.g. a label, for identifying the terminal during production and maintenance of the terminal.

### Description of Related Art

Labels are used for carrying information, e.g. for tracking and identifying products, e.g. animals to triggering equipment down oil wells. Labels are also used in the manufacturing industry for identifying different products during their manufacture, e.g. electronic portable terminals in the form of mobile/cellular phones, lap top computers, audio players, such as MP3-players, or similar devices to control and track their whereabouts within the supply chain and the type of product etc., e.g. the same mobile phone or lap top computer model may be equipped with different software, whereby this has to be tracked so that no mix-up of different products occurs etc.

In prior art label applications for mobile phones, the labels are attached, preferably by adhering, to the inside of the battery compartment, so that it may be read by a producer and its identification and whereabouts supervised.

Moreover, known devices are in some cases tampered with such that an old or stolen device is relabelled by removing the original label illegitimate and replacing it with another “false” label.

One known label tray in a mobile phone is used for both revealing and storing information and to remove and insert a battery by placing the label tray inside the battery compartment in contact with the battery such that when the label tray is gripped it can be slid in and out of the battery compartment together with the battery, i.e. the label acts as battery slide.

The disadvantages in prior art label arrangements are for example that the battery has to be removed to be able to read the label and that the labels “add” to the chain of tolerance, i.e. the thickness of the labels limits the volume inside the battery compartment and increases the height of the compartment, and, in some applications, the labels are placed inside the compartment under an overhang so that it is very difficult to read the label due to the fact that the opening under the overhang is narrow. Moreover, the labels have a limited surface that may be imprinted and also only have one imprintable side because the undersides are adhered to a surface. Furthermore, the labels may come loose or be peeled off, especially if their adhesion deteriorates, whereby stolen phones may be re-labeled or the identification of the phone associated with the label be lost during manufacturing. Furthermore, when placing the label inside the battery compartment of a mobile phone the label makes it more difficult to pull/slid the battery in and out of the compartment because the thickness tightens the battery compartment so that an increased force is required for sliding the battery in and out of the compartment.

### SUMMARY

An object of the invention is therefore to provide an improved label and label tray for portable product, especially electronic mobile terminals, which seek to mitigate, alleviate or eliminate one or more of the above-identified deficiencies in the art and disadvantages singly or in any combination.

The invention is defined by the enclosed independent claims. Embodiments are set forth by the dependent claims attached and by the following description and the drawings.

Some embodiments of the present invention provide a separately readable label because a battery or a memory card does not have to be removed before accessing and exposing the label. The label and its tray do not add to the chain of tolerances in the terminal compartment when placed outside the compartment, i.e. externally, but within the portable terminal. Moreover, the arrangement of the label and its tray also enhances the readability of the information carried by the label as the label can easily be moved from a storing position to a reading position and back without removing the battery or the memory card. The label may also be manufactured by punching out thin label sheets in one operation, which labels may be imprinted beforehand or afterwards. Thus, also the total cost for manufacturing the label and its tray may be reduced. Furthermore, the risk of tampering with the label and its tray is limited, since the label and its tray are secured in the portable terminal.

An aspect of the invention relates to an information storing device for an electronic portable terminal, including at least one compartment, which is accessible through an opening of the terminal, and at least one label, which is accessible through the terminal opening and movably connected to the terminal for movement between a storing position and a reading position and arranged externally of the compartment.

Another aspect relates to an information carrying device, wherein the label is displaceably connected to the portable terminal for displacement between the storing position and the reading position

Another aspect relates to an information carrying device, wherein the label is slidably connected to the portable terminal for sliding between the storing position and the reading position.

Another aspect relates to an information carrying device, wherein the label is rotatably connected to the electronic portable terminal for rotation between the storing position and the reading position.

Another aspect relates to an information carrying device, wherein the label is arranged adjacent any side of the compartment of the terminal.

Another aspect relates to an information carrying device, wherein the label is arranged below or above the terminal compartment when viewing the terminal opening with the terminal orientated horizontally with its back surface facing downwards.

Another aspect relates to an information carrying device, wherein the label is arranged besides the terminal compartment.

Another aspect relates to an information carrying device, wherein the label is arranged at the left or right side of the compartment of the terminal when viewing the terminal opening with the terminal orientated horizontally with its back surface facing downwards.

Another aspect relates to an information carrying device, wherein a locking device for securing the label to the terminal is arranged on the terminal compartment, integrated in the terminal compartment or a part of the terminal compartment.

Another aspect relates to an information carrying device, wherein the locking device comprises at least one hook engaging an opening in the label.

Another aspect relates to an information carrying device, wherein the locking device comprises two hooks, each hook engaging a label opening.

Another aspect relates to an information carrying device, wherein the compartment of the terminal is configured to contain a battery or a memory card.

Another aspect relates to a method of manufacturing an information storing device for an electronic portable terminal, including punching out a label in one step from a thin blank.

Another aspect relates to an information carrying device, wherein the information carrying device is intended for the usage together with the portable electronic device, wherein the portable electronic device is a device from the group comprising: a mobile radio terminal, a mobile telephone, a cellular telephone, a pager, a communicator, a smart phone, a Personal Digital Assistant (PDA), an electronic organizer, a computer, a digital audio player or a digital camera.

Another aspect relates to an information carrying device according to the description herein and/or the appended drawings.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment,” which herein after is referred to as a “mobile radio terminal,” “mobile phone,” “mobile device,” or “mobile terminal” and the like, includes all equipment such as mobile telephones, pagers, communicators, i.e., electronic organizers, personal digital assistants (PDAs), smartphones, portable communication apparatus or the like. The term “electronic equipment” also may include portable digital music devices, e.g., iPod devices, mp3 players, etc. A portable radio communication device may also be a portable digital music device.

### BRIEF DESCRIPTION OF THE DRAWINGS

The invention will now be described in more detail with reference to the drawings enclosed, in which

FIG. 1 shows a view of an electronic portable device with an opening for accessing a compartment and a label in one position, i.e. the storing position, in accordance with the invention,

FIG. 2 shows one view of the electronic portable device with the opening for accessing the compartment and the label in another position, i.e. an intermediate position,

FIG. 3 shows another view of the electronic portable device with the opening for accessing the compartment and the label in still another position, i.e. the reading position,

FIG. 4 shows one embodiment of the label according to the invention,

FIG. 5 shows another embodiment of the label according to FIG. 4,

FIG. 6 shows a locking device for securing the label to the terminal according to the invention, and

FIG. 7 shows different external label positions around the compartment according to the invention.

### DETAILED DESCRIPTION OF THE EMBODIMENTS

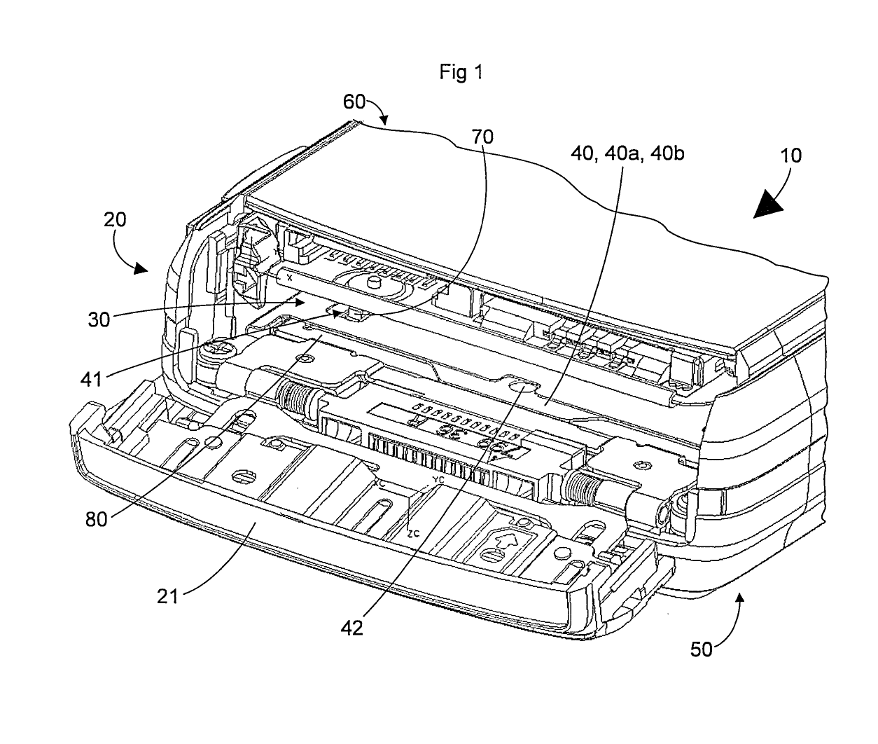

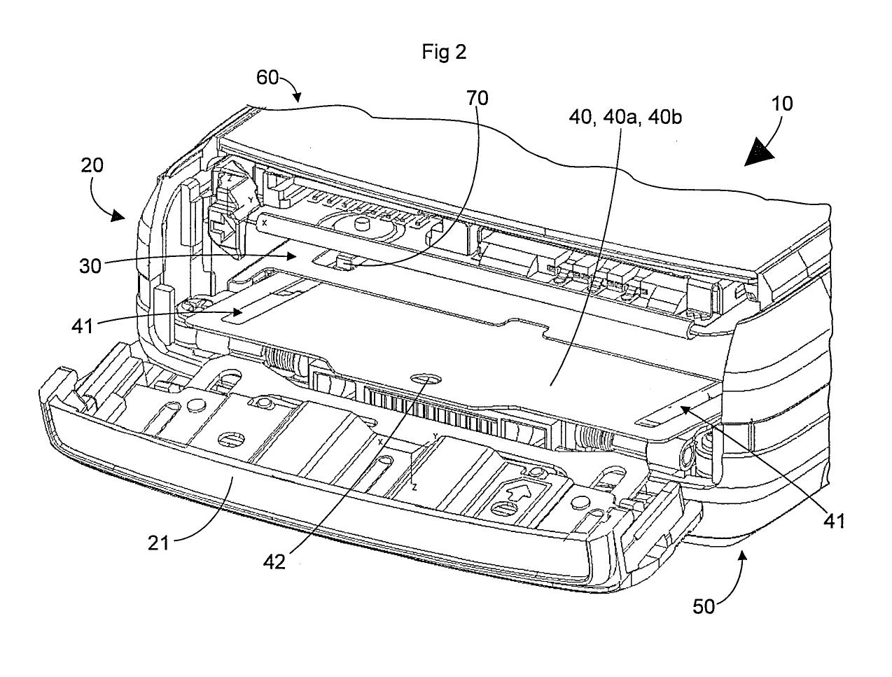

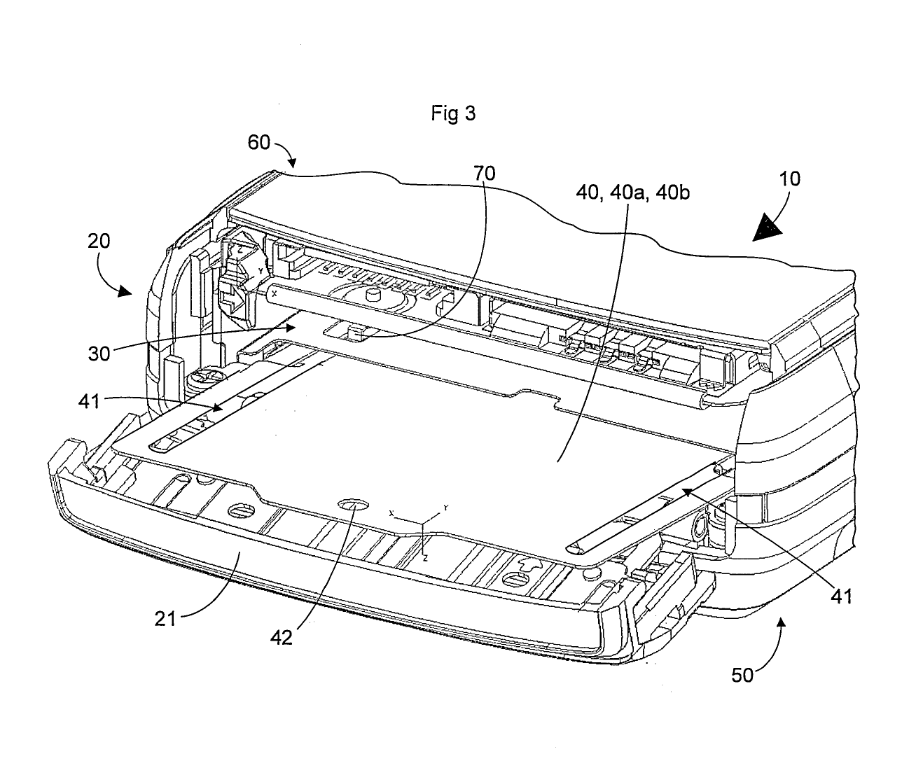

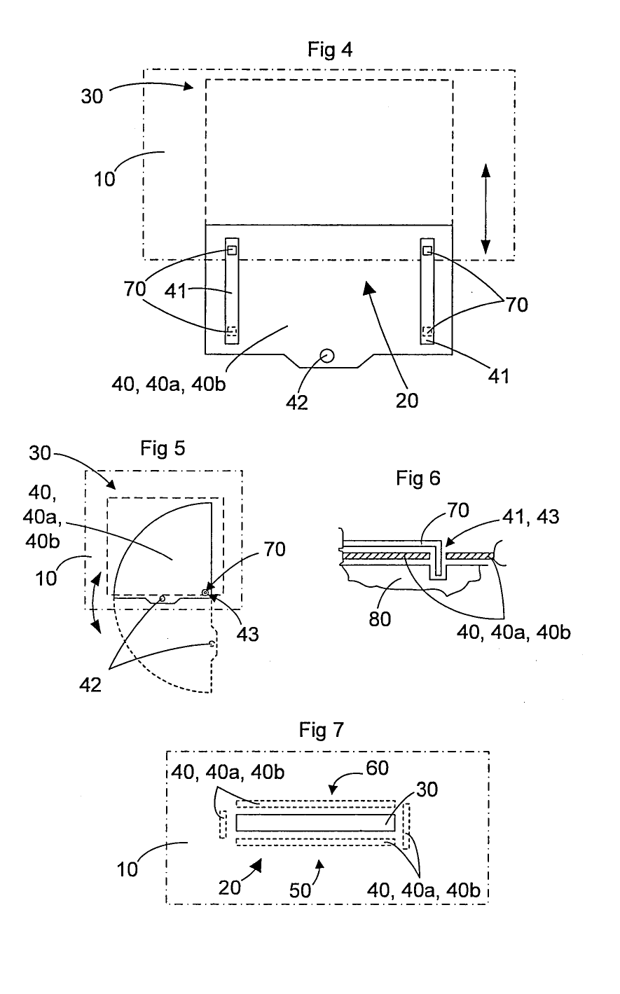

FIG. 1 to 3 show a lower part of an electronic portable terminal 10 with an opening 20 having an openable and closable hinged lid 21 for accessing at least one compartment 30 and information carrying means, i.e. terminal identification carrier 40 comprising a label 40a and a label tray 40b for identification of the terminal 10. The label 40a is also accessible through the terminal opening 20 by opening the lid 21 and the label is movably connected to the terminal for movement between a storing position shown in FIG. 1 and a reading position shown in FIG. 3 (an intermediate position between these positions is shown in FIG. 2). The label storing and reading positions are also shown in FIGS. 4 and 5 where the electronic portable terminal 10 is schematically shown with a dashed dotted line.

According to the invention, the terminal identification means 40 is arranged externally of the terminal compartment 30, so that the compartment, which may accommodate for example a battery (not shown) or a memory card (not shown), is designed as small/thin as possible, i.e. by not placing the terminal identification carrier 40 in the battery compartment, as in prior art, the chain of tolerance for the associated components in the terminal 10 is minimized.

The combined label 40a and label tray 40b according to the preferred and disclosed embodiment is preferably, but not necessarily, intended for the usage together with a portable electronic device. The portable electronic device may be any portable electronic device, such as a mobile radio terminal, a mobile telephone, a cellular telephone, a pager, a communicator, a smart phone, a Personal Digital Assistant (PDA), an electronic organizer, a computer, a digital audio player such as a MP3-player or an iPod®, or a digital camera.

The terminal identification carrier 40 is displaceably connected to the terminal 10 for displacement between the storing position in FIG. 1 and the reading position in FIG. 3. This may be done by slidably connecting the terminal identification carrier 40 to the terminal for sliding between its positions as shown in FIG. 4 or by rotatably connecting the terminal identification carrier to the terminal for rotation between these positions as shown in FIG. 5. For simplicity reasons, the terminal identification carrier 40 comprising both the label 40a and the label tray 40b, which may be either separate details or integrated details or the same detail, will be called the label 40 in the following description. The label 40 may be imprinted and carry all the terminal identification information and be attached, e.g. adhered to the tray 40b or the label 40 may only carry a part of the necessary terminal identification information while the tray 40b is provided, e.g. imprinted, with the rest of the necessary terminal identification information, or the label 40 equipped with all the terminal identification information may be an integrated part of the label tray 40b by moulding or laminating it therein. The label 40 may be imprinted with information or equipped with a micro chip comprising all the necessary information or similar information storing devices.

The label 40 may be arranged adjacent any side of the compartment 30 of the terminal 10. The label 40 may be arranged below, above or besides the terminal compartment when viewing the terminal opening 20 with the terminal 10 orientated horizontally with its back surface 50 facing downwards, as shown in FIGS. 1-3 and shown in dotted lines in FIG. 7, with a front surface 60 of the terminal facing upwards, i.e. the access opening 20 being viewed in the longitudinal direction of the terminal. If the label is arranged adjacent the side of the compartment it may be arranged at the left or the right side of the compartment 30, i.e. in view of the orientation of the terminal and its opening 20 in FIGS. 1-3 and 7, and be arranged at a short side or a long side of the terminal 10. Evidently, these positions of the label 40 is defined in relation to the adjacent terminal compartment 20 and not in relation to the terminal 10 itself, i.e. the definitions and arrangements of these label positions is independent of the orientation of the terminal and only used for clarifying the invention. This means that the opening 20 may be viewed also from the other end of the terminal and that the definitions also cover if the terminal is placed vertically or horizontally, the back 50 and front surface 60 are defined in relation to the enclosed drawings and may be any side of the terminal, e.g. when the terminal is placed upside down.

In FIG. 4, the label 40 is shown in one embodiment comprising two openings or holes 41 in the form of slits in which a locking device 70 for securing the label to the terminal 10 is engaged. The locking device may be achieved by engagement of at least one hook 70 that may be arranged on the terminal compartment 30, e.g. by attaching it to or integrating it in the compartment or by making it a part of the compartment or placing it on/at any other suitable part of the terminal 10, e.g. the printed circuit board (PCB). The slits 41 extend along the label 40 in the same direction as the label is displaced/slid when moved between the storing position (shown with dotted lines in FIG. 4) and the reading position (shown with solid lines in FIG. 4) where a main part of the label is visible in the opening 20 of the terminal so that the identification of the terminal is easy to determine, e.g. by scanning a bar code imprinted on the label or by reading imprinted text on the label 40. The length of the slits 41 corresponds substantially to the distance that the label is pulled out and in of the compartment, and the length of each slit 41 may of course have any suitable value.

In FIG. 4, the embodiment of the locking device 70 comprises two hooks, each hook engaging its associated slit 41 in the label 40, which label is substantially square with an optional widened front area with an opening 42 for engagement of a pulling tool or grip when pulling out the label. Each slit 41 extends alongside the label adjacent a label edge, the slits being symmetrically arranged on the label. Here, each of the hooks 70 has a substantially square cross-section to create more of a steering or guiding shape when the hooks move in the slits back and forth in a substantially linear path when the label is moved but may of course have a more rounded cross-section, e.g. circular.

FIG. 5 shows another embodiment of the label 40 and the locking device 70. In this embodiment, the label has a rounded shape with one side formed as a curve or arc, i.e. similar to a quarter of a circle or a rounded substantially triangular shape, and two substantially straight sides joining each other at a corner. The locking device comprises one hook 70 engaging one opening 43 with a substantially round shape, preferably circular. The opening 43 is placed at the connecting corner of the two straight sides of the label 40, so that the label may be turned/rotated from its storage position shown with a continuous line with its main part inside the terminal and non-readable to its reading position with its main part visible in the opening 20 of the terminal 10 (the two different positions for the label are distinguished by solid and dashed lines in FIG. 5) and in some embodiments the label protrudes out of the terminal. This pivoting function for the label is achieved in that the locking hook 70 in this embodiment is rounded, e.g. with a circular cross-section, fitting into the rounded opening 43 so that the label may rotate around the hook creating a curved/circular path for the label between its storing/non-readable position and reading position.

In FIG. 6, the locking device 70 is shown with a free end in engagement with the label 40 and another component 80 of the terminal 10, e.g. an upper surface of a printed circuit board (PCB), as shown in FIG. 1. The engagement between the end of the locking hook 70 and a cavity, groove or opening in the PCB 80 enhances the securing effect of the locking device and keeps the label in a tamper-proof grip, i.e. this increases or stiffens the end of the hook in that the PCB opening works in a similar way as an anvil supporting the hook end, so that the force for bending the hook is increased considerably when compared to having the hook end wholly free. This also means that the label 40 is more securely held in place as it can not slip or pass between the hook end and the component 80 as there is no gap between them.

The label 40 is manufactured by punching, i.e. the label 40 is punched out in one operation with its slits 41 and holes 42 and 43, whereby no additional after-treatment or process is required. This means that the label is easy to produce and also may be easily manufactured in a recycleable plastic material. The label blank may be imprinted before the punching operation or after, or, alternatively, the label blank may be partly imprinted with some information before the punch operation and the finished label may be imprinted with the rest of the information after the punching. Moreover, information may also be introduced in the label, i.e. the label tray 40b during the manufacturing of the label blanks, e.g. when moulding the blanks. Furthermore, the label blanks may be very thin, about 0.2 mm thick, i.e. between 0.1 and 0.5 mm, and preferably between 0.15 and 0.25 mm.

1. An information storing device for an electronic portable terminal, comprising at least one compartment, which is accessible through an opening of the terminal, and at least one label, which is accessible through the terminal opening and movably connected to the terminal for movement between a storing position and a reading position and arranged externally of the compartment.

2. An information carrying device according to claim 1, wherein the label is displaceably connected to the portable terminal for displacement between the storing position and the reading position

3. An information carrying device according to claim 2, wherein the label is slidably connected to the portable terminal for sliding between the storing position and the reading position.

4. An information carrying device according to claim 2, wherein the label is rotatably connected to the electronic portable terminal for rotation between the storing position and the reading position.

5. An information carrying device according to claim 1, wherein the label is arranged adjacent any side of the compartment of the terminal.

6. An information carrying device according to claim 1, wherein the label is arranged below or above the terminal compartment when viewing the terminal opening with the terminal orientated horizontally with its back surface facing downwards.

7. An information carrying device according to claim 1, wherein the label is arranged besides the terminal compartment.

8. An information carrying device according to claim 1, wherein the label is arranged at the left or right side of the compartment of the terminal when viewing the terminal opening with the terminal orientated horizontally with its back surface facing downwards.

9. An information carrying device according to claim 7, wherein the label is arranged at the left or right side of the compartment of the terminal when viewing the terminal opening with the terminal orientated horizontally with its back surface facing downwards.

10. An information carrying device according to claim 1, wherein a locking device for securing the label to the terminal is arranged on the terminal compartment, integrated in the terminal compartment or a part of the terminal compartment.

11. An information carrying device according to claim 10, wherein the locking device comprises at least one hook engaging at least one opening in the label.

12. An information carrying device according to claim 10, wherein the locking device comprises two hooks, each hook engaging a label opening.

13. An information carrying device according to claim 1, wherein the compartment of the terminal is configured to contain a battery or a memory card.

14. A method of manufacturing an information storing device for an electronic portable terminal, comprising punching out a label in one step from a thin blank.

15. The information carrying device as recited in claim 1, wherein the information carrying device is intended for the usage together with the portable electronic device, wherein the portable electronic device is a device from the group comprising: a mobile radio terminal, a mobile telephone, a cellular telephone, a pager, a communicator, a smart phone, a Personal Digital Assistant (PDA), an electronic organizer, a computer, a digital audio player or a digital camera.

16. (Canceled)
